(19) United States
(12) Patent Application Publication
(10) Pub. No.: US 2009/0060684 A1
(43) Pub. Date: Mar. 5, 2009

(54) Robot

(75) Inventor: Hideichi Nakamoto, Yokohama-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/073,563

(22) Filed: Mar. 6, 2008

(30) Foreign Application Priority Data
Aug. 29, 2007 (JP) 2007-222181

(51) Int. Cl. B25J 3/00

(52) U.S. Cl. 414/1; 901/27

(57) ABSTRACT

A robot according to an embodiment of the present invention includes: a robot body; a first shoulder joint attached to the robot body, and rotatable with respect to the robot body; a support unit whose proximal end is attached to the first shoulder joint, and which is rotatable with respect to the robot body together with the first shoulder joint; a second shoulder joint attached to a distal end of the support unit, and rotatable with respect to the support unit; and an arm unit whose proximal end is attached to the second shoulder joint, and which is rotatable with respect to the support unit together with the second shoulder joint.

### CROSS REFERENCE TO RELATED APPLICATIONS

This application is based upon and claims the benefit of priority from the prior Japanese Patent Application No. 2007-222181, filed on Aug. 29, 2007, the entire contents of which are incorporated herein by reference.

### BACKGROUND OF THE INVENTION

1. Field of the Invention The present invention relates to a robot.

2. Background Art

Conventionally, arm robots have been developed mainly for work at plants and the like. In many cases, such arm robots perform limited operations or handle work objects of predetermined shapes. On the other hand, in recent years, progress has been made in developing arm robots for use in home or facility environments. Such arm robots are supposed, for example, to work around human beings, and to carry out work for the human beings or help the human beings with the work, with robot arms connected to robot bodies.

The arm robots for use in home or facility environments, for example, pick up things from the floor or handle things on a table. This requires an arm with such a wide movement range as to reach the things on the floor or table. Accordingly, JP-A H11-156769 (KOKAI) proposes a configuration in which a direct-acting joint is installed at the root of or in the middle of an arm to extend the movement range of the arm.

However, the configuration disclosed in JP-A H11-156769 (KOKAI) has a problem in that the direct-acting joint increases overall size and weight of the robot. In addition, if the direct-acting joint is installed in the middle of the arm, weight of the arm itself will be increased. Furthermore, this configuration will make the robot look awkward.

On the other hand, if the arm has a wide movement range, the arm may interfere with the body. To deal with this situation, JP-A 2006-297537 (KOKAI) proposes a configuration in which the degree of freedom of the arm is increased to avoid interference between the arm and the body.

However, the configuration disclosed in JP-A 2006-297537 (KOKAI) has a problem in that the increases in the degree of freedom will complicate the configuration and increase the weight.

Regarding the arm robots for use in home or facility environments, it is desired that the movement range of the arm be extended as much as possible while minimizing the size of the body and arm, in order to simplify the configuration, reduce the weight, and alleviate the awkward appearance of the arm robots. Furthermore, it is desirable to avoid interference between the body and arm as well as to avoid increases in the degree of freedom of the arm. It is desirable to satisfy these requirements and thereby realize a robot suitable for working around human beings.

### SUMMARY OF THE INVENTION

An embodiment of the present invention is, for example, a robot including: a robot body; a first shoulder joint attached to the robot body, and rotatable with respect to the robot body; a support unit whose proximal end is attached to the first shoulder joint, and which is rotatable with respect to the robot body together with the first shoulder joint; a second shoulder joint attached to a distal end of the support unit, and rotatable with respect to the support unit; and an arm unit whose proximal end is attached to the second shoulder joint, and which is rotatable with respect to the support unit together with the second shoulder joint.

Another embodiment of the present invention is, for example, a robot including: a robot body; and first and second robot arms attached to the robot body, each of the first and second robot arms including: a first shoulder joint attached to the robot body, and rotatable with respect to the robot body, a support unit whose proximal end is attached to the first shoulder joint, and which is rotatable with respect to the robot body together with the first shoulder joint, a second shoulder joint attached to a distal end of the support unit, and rotatable with respect to the support unit, and an arm unit whose proximal end is attached to the second shoulder joint, and which is rotatable with respect to the support unit together with the second shoulder joint.

### BRIEF DESCRIPTION OF THE DRAWINGS

FIG. 1 is a perspective view showing a configuration of an arm robot according to an embodiment;

FIG. 2 is a front view showing the configuration of the arm robot according to the embodiment;

FIGS. 3A and 3B are top views illustrating movement ranges of robot arms;

FIG. 4 is a side view illustrating a shape of a robot body;

FIGS. 5A to 5D are top views illustrating a shape of robot arms;

FIGS. 6A and 6B are side views illustrating an extended state of a robot arm;

FIGS. 7A to 7C are side views illustrating a normal state of robot arms;

FIG. 8 is a perspective view illustrating a configuration of the arm robot;

FIGS. 9A and 9B are side views illustrating a folded state of a robot arm; and

FIG. 10 is a top view illustrating a dual-arm operation of the arm robot.

### DESCRIPTION OF THE EMBODIMENTS

An embodiment of an arm robot according to the present invention will be described in detail with reference to the drawings. However, it should be noted that the present invention is not limited to this embodiment.

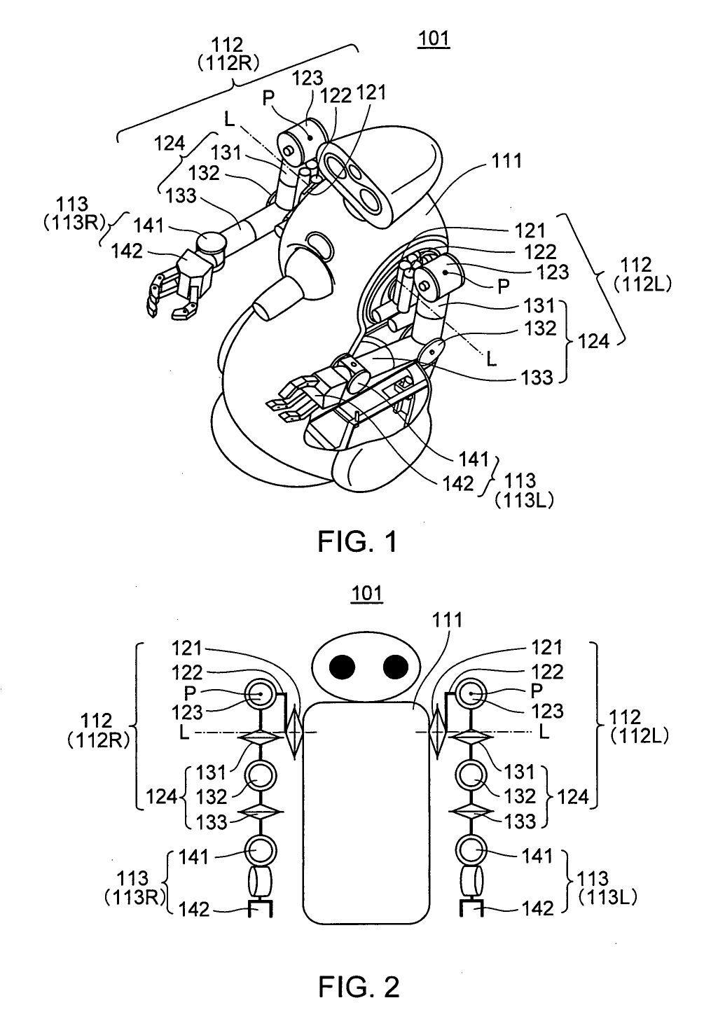

FIGS. 1 and 2 are a perspective view and a front view showing a configuration of an arm robot 101 according to an embodiment. The arm robot 101 includes a robot body 111, two robot arms 112, and two robot hands 113. Although the arm robot 101 in this embodiment has two pairs of a robot arm 112 and a robot hand 113, it may have only one pair of a robot arm 112 and a robot hand 113, or three or more pairs of a robot arm 112 and a robot hand 113.

In FIGS. 1 and 2, a robot arm 112 and a robot hand 113 which correspond to a right arm and a right hand are denoted by 112R and 113R, and a robot arm 112 and a robot hand 113 which correspond to a left arm and a left hand are denoted by 112L and 113L. One of the robot arms 112 is an example of a first robot arm, and the other of the robot arms 112 is an example of a second robot arm. The robot hand 113 for the first robot arm will be referred to as a first robot hand, and the robot hand 113 for the second robot arm will be referred to as a second robot hand. The robot arms 112 and the robot hands 113 constitute the arm robot 101 in conjunction with the robot body 111 which corresponds to a trunk. A robot arm 112 and a robot hand 113 will be described with reference to FIGS. 1 and 2. The following description applies to the right arm and the right hand as well as to the left arm and the left hand.

The robot arm 112 is connected to the robot body 111, and has a first shoulder joint 121, a support unit 122, a second shoulder joint 123, and an arm unit 124.

The first shoulder joint 121 is connected to the robot body 111, and can rotate with respect to the robot body 111. The first shoulder joint 121 is connected to the robot body 111 in such a way as to be rotatable on a certain rotation axis. Such a rotation axis L is shown in FIGS. 1 and 2. When the first shoulder joint 121 rotates with respect to the robot body 111, the first shoulder joint 121 rotates on the rotation axis L. In this case, the first shoulder joint 121 has one degree of freedom.

The support unit 122 is fixed to the first shoulder joint 121, and can rotate with respect to the robot body 111 together with the first shoulder joint 121. When the first shoulder joint 121 rotates on the rotation axis L, the support unit 122 rotates around the rotation axis L together with the first shoulder joint 121. The support unit 122 has a fixed length. A proximal end of the support unit 122 is attached to the first shoulder joint 121. A distal end of the support unit 122 is attached to the second shoulder joint 123.

The second shoulder joint 123 is supported by the support unit 122, and can rotate with respect to the robot body 111 together with the first shoulder joint 121. When the first shoulder joint 121 rotates on the rotation axis L, the second shoulder joint 123 rotates around the rotation axis L together with the first shoulder joint 121. Furthermore, the second shoulder joint 123 can rotate with respect to the support unit 122. The second shoulder joint 123 is supported by the support unit 122 in such a way as to be rotatable around a certain rotation center. Such a rotation center P is shown in FIGS. 1 and 2. When the second shoulder joint 123 rotates with respect to the support unit 122, the second shoulder joint 123 rotates around the rotation center P. In this case, the second shoulder joint 123 has two degrees of freedom.

In this embodiment, when the first shoulder joint 121 rotates on the rotation axis L, the support unit 122 and the second shoulder joint 123 rotate around the rotation axis L together with the first shoulder joint 121. Furthermore, in this embodiment, the support unit 122 has a fixed length, and the rotation center P of the second shoulder joint 123 is located away from the rotation axis L of the first shoulder joint 121. Consequently, when the first shoulder joint 121 rotates on the rotation axis L, the rotation center P rotates along a circular path whose center is on the rotation axis L. Such a circular path C is shown in FIG. 4 described later.

The arm unit 124 is connected to the second shoulder joint 123. The arm unit 124 in this embodiment has an upper arm unit 131, an elbow joint 132, and a forearm unit 133. The upper arm unit 131 is connected to the second shoulder joint 123. Specifically, the upper arm unit 131 is connected to the second shoulder joint 123 on the opposite side from the support unit 122. The elbow joint 132 is connected to the upper arm unit 131, and can rotate with respect to the upper arm unit 131. Specifically, the elbow joint 132 is connected to the upper arm unit 131 on the opposite side from the second shoulder joint 123. In this case, the elbow joint 132 has one degree of freedom. The forearm unit 133 is connected to the elbow joint 132. Specifically, the forearm unit 133 is connected to the elbow joint 132 on the opposite side from the upper arm unit 131.

The robot hand 113 is connected to the robot arm 112, and has a wrist joint 141 and a hand unit 142.

The wrist joint 141 is connected to the arm unit 124, and can rotate with respect to the arm unit 124. The wrist joint 141 in this embodiment is connected to the forearm unit 133, and can rotate with respect to the forearm unit 133. The wrist joint 141 is connected to the forearm unit 133 on the opposite side from the elbow joint 132. In this case, the wrist joint 141 has three degrees of freedom.

The hand unit 142 is connected to the wrist joint 141. Specifically, the hand unit 142 is connected to the wrist joint 141 on the opposite side from the forearm unit 133. The hand unit 142 in this embodiment is configured to be capable of acting physically on a work object, such as gripping the work object. Examples of such a configuration include a hand unit 142 which has a plurality of fingers.

As described above, the first shoulder joint 121 is attached to the robot body 111, and can rotate with respect to the robot body 111. The support unit 122 has a proximal end attached to the first shoulder joint 121, and can rotate with respect to the robot body 111 together with the first shoulder joint 121. The second shoulder joint 123 is attached to a distal end of the support unit 122, and can rotate with respect to the support unit 122. The arm unit 124 has a proximal end attached to the second shoulder joint 123, and can rotate with respect to the support unit 122 together with the second shoulder joint 123.

Further, the upper arm unit 131 has a proximal end attached to the second shoulder joint 123. The elbow joint 132 is attached to a distal end of the upper arm unit 131, and can rotate with respect to the upper arm unit 131. The forearm unit 133 has a proximal end attached to the elbow joint 132, and can rotate with respect to the upper arm unit 131 together with the elbow joint 132.

Further, the wrist joint 141 is attached to a distal end of the arm unit 124 (forearm unit 133), and can rotate with respect to the arm unit 124 (forearm unit 133). The hand unit 142 is attached to the wrist joint 141, and can rotate with respect to the arm unit 124 (forearm unit 133) together with the wrist joint 141.

As described above, in this embodiment, the robot arm 112 has two shoulder joints which are the first shoulder joint 121 and second shoulder joint 123, and is provided with the support unit 122 between these shoulder joints. This makes it possible to realize a robot arm 112 having a wide movement range. As described later, this embodiment can provide, for example, an arm which can be extended and retracted. Thereby, this embodiment can provide an arm having a wide movement range.

In this embodiment, the first shoulder joint 121 has one degree of freedom, the second shoulder joint 123 has two degrees of freedom, the elbow joint 132 has one degree of freedom, and the wrist joint 141 has three degrees of freedom. Therefore, the arm of the arm robot 101 (from the shoulder to the wrist) has seven degrees of freedom. This number is equal to that of an arm of a human.

Generally, if a robot arm has six degrees of freedom, a robot hand attached to the robot arm can take any position and posture. However, in order to avoid singularities and obstacles, it is desirable to give the arm redundant degrees of freedom, i.e., it is desirable to give the arm more than six degrees of freedom. For this reason, arms with seven degrees of freedom have been eagerly developed. Furthermore, arms with more than seven degrees of freedom also have been developed to avoid interference between the arms and bodies. However, increase in the degrees of freedom of an arm results in increase in the arm size, increase in the arm weight, and complication of an arm mechanism.

In this embodiment, a wide movement range of an arm can be realized by an arm which includes the first shoulder joint 12.1, the support unit 122, and the second shoulder joint 123. Therefore, in this embodiment, it is possible to provide a wide movement range of an arm and avoid interference between the arm and body, by an arm which has relatively low degrees of freedom. Therefore, this embodiment can suppress the degrees of freedom of an arm, and thereby can suppress increase in the arm size, increase in the arm weight, and complication of an arm mechanism.

In this embodiment, there is no need to install a direct-acting joint in the arm. This makes it possible to reduce the weight of the arm and prevent the robot from looking awkward.

In this embodiment, the arm may have degrees of freedom other than seven. For example, the number of the degrees of freedom may be reduced to six by not installing the elbow joint 132 in the robot arm 112. Otherwise, the number of the degrees of freedom may be reduced to four by not attaching the robot hand 113 to the robot arm 112. Otherwise, the number of the degrees of freedom may be increased to eight by changing degrees of freedom of the second shoulder joint 123 to three. Furthermore, the above options may be used in combination.

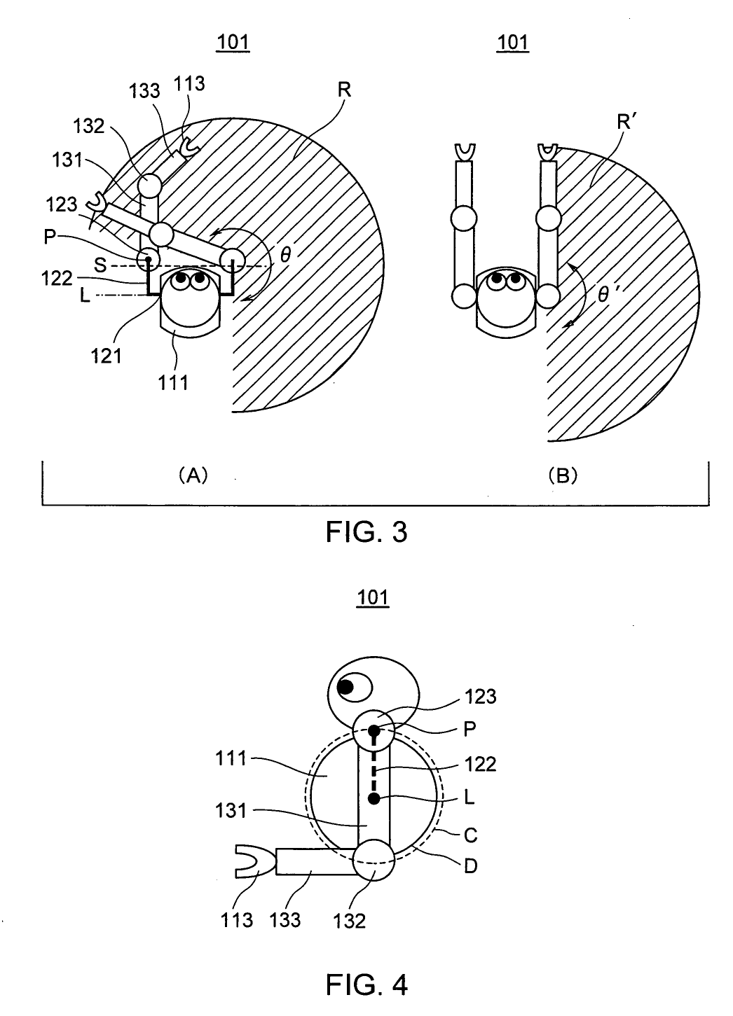

FIGS. 3A and 3B are top views illustrating movement ranges of the robot arms 112.

In this embodiment, the position of the second shoulder joint 123 can be changed by rotating the first shoulder joint 121 on the rotation axis L. FIG. 3A shows a state in that the first shoulder joint 121 is rotated so as to place the second shoulder joint 123 forward. Consequently, in FIG. 3A, the second shoulder joint 123 is located toward the distal end of the arm unit 124. FIG. 3A also shows the rotation axis L of the first shoulder joint 121 and the rotation center P of the second shoulder joint 123.

FIG. 3A shows a plane S. The plane P is a tangent plane to the front of the robot body 111. In this embodiment, the length of the support unit 122, i.e., the distance between the rotation axis L and the rotation center P, is larger than the distance between the rotation axis L and the plane S. Consequently, in this embodiment, when the first shoulder joint 121 is rotated so as to place the second shoulder joint 123 forward, the rotation center P is placed forward of the plane S. As a result, the maximum movement angle of the second shoulder joint 123 in a horizontal plane becomes larger than 180 degrees as shown in FIG. 3A, which makes it possible to bring the robot arm 112 to the front of the robot body 111. This makes it easy for the robot arm 112 to carry out operations in front of the robot body 111. FIG. 3A shows an angle θ and a region R. The angle θ represents the maximum movement angle of the support unit 122 in a horizontal plane. The region R represents the maximum movement range of the robot arm 112 due to rotation of the second shoulder joint 123.

As described above, in this embodiment, the length of the support unit 122 is large enough to bring the rotation center P forward of the plane S. This reduces interference between the arm and body and increases the movement range of the arm as shown in FIG. 3A. Thereby, the common movement range of the two arms is increased, which increases a range in which the two arms can perform collaborative work.

On the other hand, when a robot arm has only one shoulder joint, the movement range of the arm is as shown in FIG. 3B. FIG. 3B shows an angle θ′ and a region R′. The angle θ′ represents the maximum movement angle of the shoulder joint in a horizontal plane. The region R′ represents the maximum movement range of the robot arm due to rotation of the shoulder joint. In this case, the common movement range of the two arms is narrow, which decreases a range in which the two arms can perform collaborative work.

FIG. 4 is a side view illustrating the shape of the robot body 111.

When the first shoulder joint 121 rotates on the rotation axis L, the support unit 122 and the second shoulder joint 123 rotate around the rotation axis L together with the first shoulder joint 121. In this way, the second shoulder joint 123 can rotate with respect to the robot body 111. In this case, the second shoulder joint 123 rotates along a rotational path, which is shown in FIG. 4 as a path C. The path C is a circular path whose center is on the rotation axis L. When the first shoulder joint 121 rotates on the rotation axis L, the rotation center P of the second shoulder joint 123 rotates along the path C.

To avoid interference between the robot body 111 and the robot arm 112, it is desirable that the path C be far outside of the robot body 111. For this reason, it is desirable that the robot body 111 be as small as possible. However, since the robot body 111 is generally equipped with various parts such as a controller and a battery, there are limits to downsizing of the robot body 111. Therefore, in this embodiment, it is desired that the shape of the robot body 111 in the vicinity of the path C be such as to fit within the path C, while maintaining the size of the robot body 111 large enough to be equipped with necessary parts.

Therefore, in this embodiment, it is preferred that at least a part of the robot body 111 has a shape which approximately conforms to the path C. This is shown as a contour D in FIG. 4. The contour D represents the shape of the robot body 111 in the vicinity of the path C. The contour D conforms to an inner side of the path C. In this way, in this embodiment, the shape of the robot body 111 at least partly conforms to the path C. This makes it possible to ensure an appropriate size for the robot body 111, while avoiding interference between the robot body 111 and the robot arm 112.

In this embodiment, the shape of the robot body 111 in the vicinity of the path C conforms to the path C. It is desirable that the shape of the robot body 111 conform to the path C in a wide region of the robot body 111.

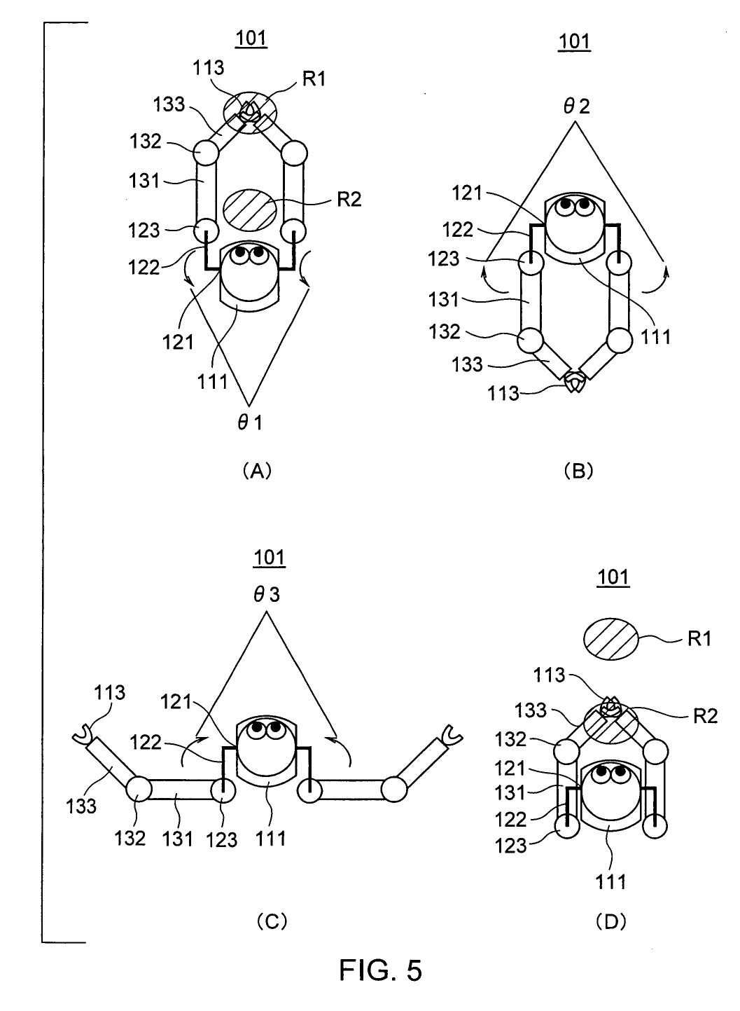

FIGS. 5A to 5D are top views illustrating the shape of the robot arms 112.

FIG. 5A shows a state in that the first shoulder joints 121 are rotated so as to place the second shoulder joints 123 forward. In this way, in this embodiment, the length of the robot arms 112 can be increased by rotating the first shoulder joints 121 so as to bring the second shoulder joints 123 forward.

FIG. 5A shows a distant region R1 located away from the robot body 111 and a nearby region R2 located near the robot body 111. The robot arms 112, when in a state shown in FIG. 5A, are suited to handle a work object in the distant region R1. This is because the arms have a longer reach. However, the robot arms 112, when in a state shown in FIG. 5A, are not suited to handle a work object in the nearby region R2. This is because the arms are so long that it is hard to carry out operations. In addition, when the arms are extended more than necessary, they increase the inertial force acting on the robot body 111. For this reason, in this embodiment, the robot arms 112 are changed from the state shown in FIG. 5A to the state shown in FIG. 5D, when handling a work object located in the nearby region R2. FIG. 5D shows a state in that the first shoulder joints 121 are rotated so as to place the second shoulder joints 123 backward. Consequently, in FIG. 5D, the second shoulder joints 123 are located in the opposite direction from the distal ends of the arm units 124.

The following description will describe an example of a process for changing the robot arms 112 from the state shown in FIG. 5A to the state shown in FIG. 5D. First, the first shoulder joints 121 are rotated on the rotation axis L as indicated by θ1 in FIG. 5A. Consequently, as shown in FIG. 5B, the robot arms 112 are placed behind the robot body 111 with the second shoulder joints 123 located backward. Next, the second shoulder joints 123 are rotated around the rotation center P as indicated by θ2 in FIG. 5B. Consequently, as shown in FIG. 5C, the robot arms 112 are placed on the sides of the robot body 111 with the second shoulder joints 123 located backward. Next, the second shoulder joints 123 are rotated around the rotation center P as indicated by θ3 in FIG. 5C. Consequently, as shown in FIG. 5D, the robot hands 113 are placed in front of the robot body 111 with the second shoulder joints 123 located backward.

FIG. 5A and FIG. 5D will be compared hereinafter. In FIG. 5A, the second shoulder joints 123 are located forward and the robot hands 113 are located in front of the robot body 111. In this way, in this embodiment, the robot hands 113 can be placed away from the robot body 111 by rotating the first shoulder joints 121 so as to bring the second shoulder joints 123 forward. On the other hand, in FIG. 5D, although the second shoulder joints 123 are located backward, the robot hands 113 are located in front of the robot body 111. In this way, in this embodiment, the robot hands 113 can be placed near the robot body 111 by rotating the first shoulder joints 121 so as to bring the second shoulder joints 123 backward. The robot arms 112, when in a state shown in FIG. 5D, are suited to handle a work object in the nearby region R2.

In FIG. 5D, it is desirable to avoid interference between the robot body 111 and the forearm 133. For this reason, it is desirable that the length of the upper arm unit 131 be twice or more larger than the length of the support unit 122. This means that the distance between the rotation center P and the rotation axis of the elbow joint 132 is twice or more larger than the distance between the rotation axis L and the rotation center P. In FIG. 5D, this makes it possible to place the elbow joint 132 forward of the plane S, which makes it possible to place the forearm unit 133 in front of the robot body 111.

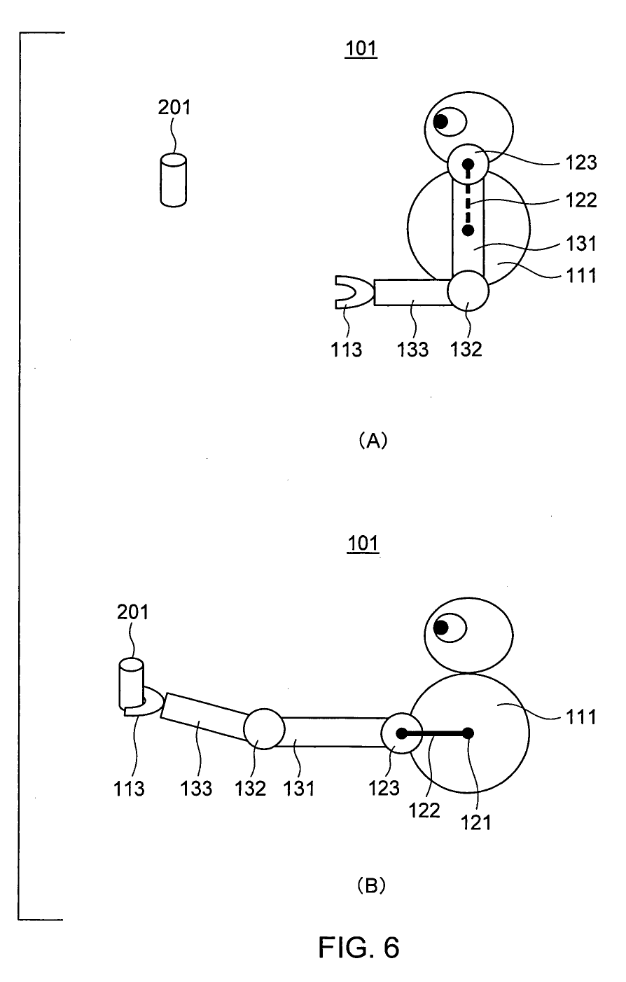

FIGS. 6A and 6B are side views illustrating an extended state of the robot arm 112.

FIG. 6A shows a positional relation between the robot 101 and a work object 201. In FIG. 6A, the work object 201 is located ahead of the robot 101. In FIG. 6A, the robot arm 112 cannot reach the work object 201, even if the second shoulder joint 123 and elbow joint 132 are driven.

In this embodiment, the position of the second shoulder joint 123 can be changed by rotating the first shoulder joint 121. In FIG. 6A, although the work object 201 is located ahead of the robot 101, the second shoulder joint 123 is located upward. In such a case, in this embodiment, the first shoulder joint 121 is rotated so as to bring the second shoulder joint 123 forward. This makes it possible to bring the robot arm 112 close to the work object 201. Furthermore, in this embodiment, the second shoulder joint 123 and elbow joint 132 are driven so as to bring the robot arm 112 close to the work object 201. Consequently, the robot arm 112 reaches the work object 201 as shown in FIG. 6B.

In this embodiment, the robot arm 112 (arm unit 124) can be driven in such a manner as described above, when it is used for work. That is, the first shoulder joint 121 can be rotated so as to bring the second shoulder joint 123 in the direction of the work object 201. Consequently, the length of the robot arm 112 (length from the shoulder to the wrist) can be extended in the direction of the work object 201, which allows the robot 101 to handle the work object 201 that is located away from the robot 101.

In this way, in this embodiment, the position of the second shoulder joint 123 can be changed according to the position of the work object 201. This allows the arm to reach various distances.

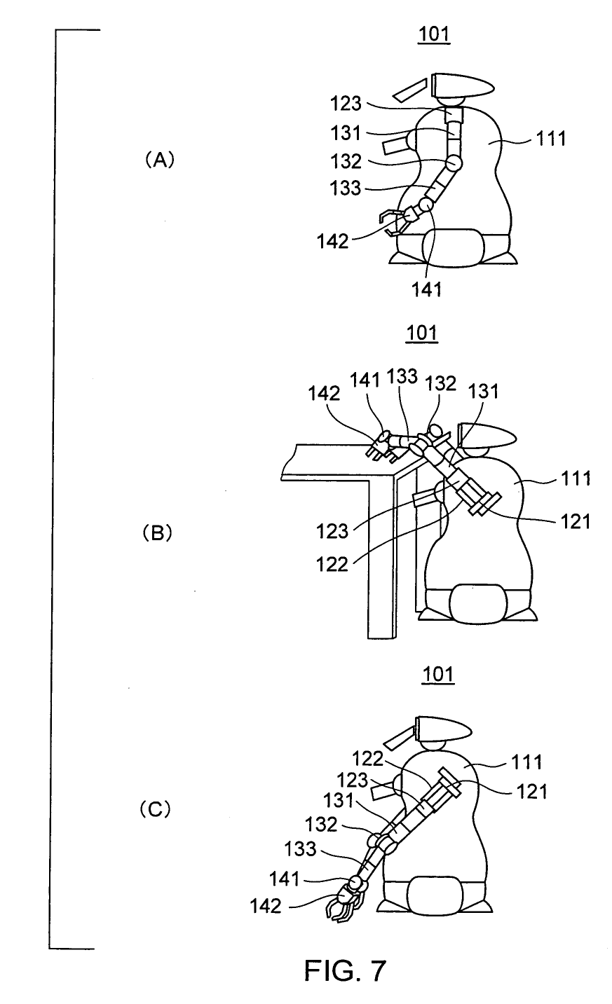

FIGS. 7A to 7C are side views illustrating a normal state of the robot arms 112.

FIG. 7A shows the robot arms 112 in the normal state. In this embodiment, when the robot arms 112 (arm units 124) are not used for work, the robot arms 112 are put in the normal state as shown in FIG. 7A. That is, the second shoulder joints 123 are rotated so as to bring the distal ends of the arm units 124 close to the robot body 111. Here in particular, the first shoulder joints 121 are rotated so as to place the second shoulder joints 123 upward or downward, and the second shoulder joints 123 are rotated so as to turn the upper arm units 131 downward. Consequently, it is possible to bring the robot arms 112 close to the robot body 111 as shown in FIG. 7A. The forearm units 133 may face straight downward, or may face obliquely downward as shown in FIG. 7A. Orientation of the forearm units 133 can be controlled through rotation of the elbow joints 132.

As described above, if the arms are extended more than necessary, they increase the inertial force acting on the robot body 111. Therefore, in this embodiment, the robot arms 112 are brought close to the robot body 111, when they are not used for work. This increases stability of the robot 101.

FIGS. 7B and 7C show the robot arms 112 in the extended state. The robot 101 in FIG. 7B is carrying out an operation of handling a thing (e.g. food) on a table. In FIG. 7B, the first shoulder joints 121 are rotated so as to place the second shoulder joints 123 in the direction of the food, and the robot arms 112 are turned toward the food. The robot 101 in FIG. 7C is carrying out an operation of picking up a thing (e.g. trash) from the floor. In FIG. 7C, the first shoulder joints 121 are rotated so as to place the second shoulder joints 123 in the direction of the trash, and the robot arms 112 are turned toward the trash.

As described above, in this embodiment, the robot arms 112 can be put in the extended state when they are used, and the robot arms 112 can be put in the normal state when they are not used. Consequently, in this embodiment, it is possible to realize a wide movement range of the robot arms 112 and improved stability of the robot 101 at the same time. For example, this embodiment can provide a robot 101 which is small but includes a robot arm 112 having a wide movement range. Further, this embodiment can provide a robot arm 112 which is short but has a wide movement range.

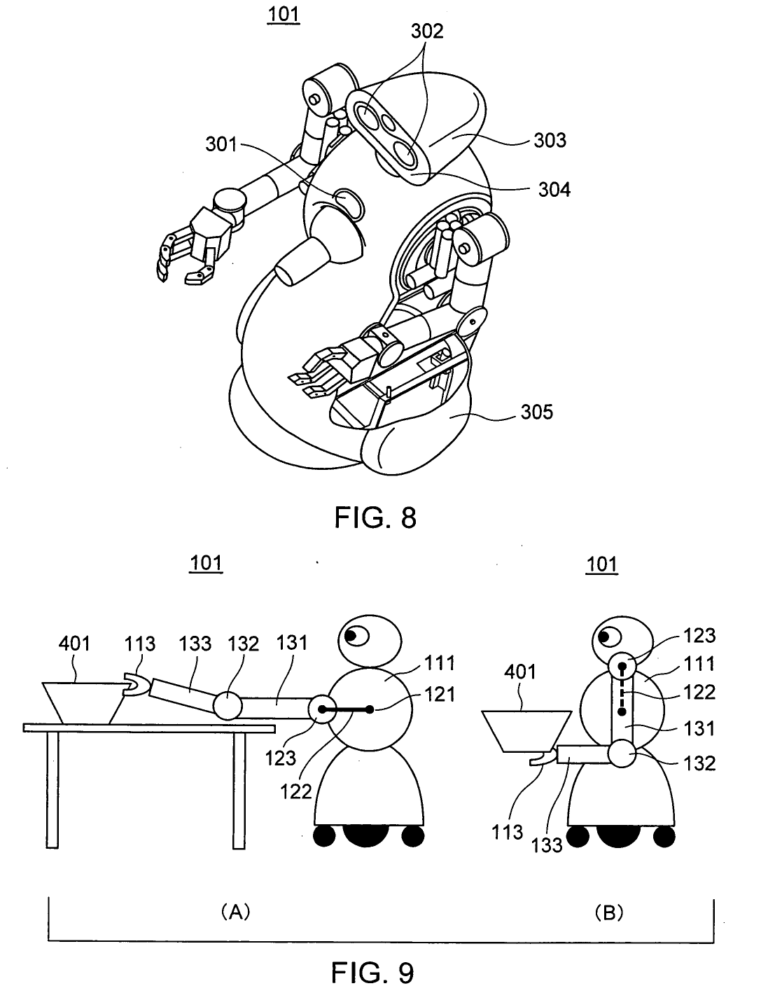

FIG. 8 is a perspective view illustrating a configuration of the arm robot 101.

As shown in FIG. 8, the arm robot 101 further includes an obstacle detecting unit 301, a work object detecting unit 302, a microphone unit 303, a speaker unit 304, and a locomotive unit 305. The obstacle detecting unit 301 is a component for detecting obstacles around the robot 101. The obstacle detecting unit 301 includes, for example, an ultrasonic sensor or an infrared sensor. The work object detecting unit 302 is a component for detecting the position and the posture of the work object 201. The work object detecting unit 302 includes, for example, a camera or an infrared distance sensor. The microphone unit 303 is a component for voice input. The microphone unit 303 is used, for example, to perform operations by listening to commands from people, or to make an emergency stop by sensing an abnormal sound. The speaker unit 304 is a component for voice output. The speaker unit 304 is used, for example, to inform people about operating condition, or to secure safety by informing people nearby about robot operation. The locomotive unit 305 is a component for moving the robot 101. The locomotive unit 305 can extend the reachable distance of the robot arms 112 by locomotion. Further, the arm robot 101 contains a controller (not shown) which controls the robot arms 112, robot hands 113, obstacle detecting unit 301, work object detecting unit 302, microphone unit 303, speaker unit 304, locomotive unit 305, and the like.

FIGS. 9A and 9B are side views illustrating a folded state of the robot arm 112.

FIG. 9A shows the robot 101 which is about to hold a thing (work object) 401 with the robot arm 112. In FIG. 9A, the robot arm 112 is put in the extended state, because the thing 401 is located away from the robot 101.

The following description will describe a situation in which the robot 101 carries the thing 401 by holding the thing 401 in the robot arm 112. In this case, if the robot 101 carries the thing 401 with the robot arm 112 extended, the inertial force acting on the robot body 111 is large.

Therefore, in this embodiment, the robot arm 112 is put in the folded state as shown in FIG. 9B, when carrying the thing 401 by holding the thing 401 in the robot arm 112. That is, the second shoulder joint 123 is rotated so as to bring the distal end of the arm unit 124 close to the robot body 111. Here in particular, the first shoulder joint 121 is rotated so as to place the second shoulder joint 123 upward or downward, and the second shoulder joint 123 is rotated so as to turn the upper arm unit 131 downward. This is similar to the normal state of the robot arm 112. The forearm unit 133 may be turned straight sideways, obliquely upward, or obliquely downward.

In this embodiment, the reachable distance of the robot arm 112 can be shortened by putting the robot arm 112 in the folded state, as the robot arm 112 in the normal state. This increases stability of the robot 101. Furthermore, in this embodiment, the moment of inertia added to the thing 401 can be decreased by putting the robot arm 112 in the folded state. This is because the distance between the central axis of the robot 101 and the central axis of the thing 401 is reduced when the robot 101 and the thing 401 come close to each other. Consequently, when the robot 101 carries the thing 401, the inertial force acting on the thing 401 is reduced, which allows the robot 101 to carry the thing 401 in a stable manner. This is particularly effective when the thing 401 is a liquid.

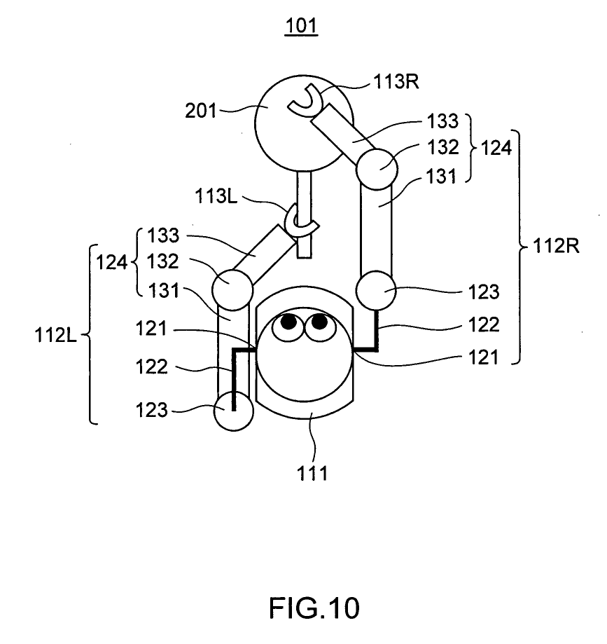

FIG. 10 is a top view illustrating a dual-arm operation of the arm robot 101.

In FIG. 10, a robot arm 112 and a robot hand 113 which correspond to a right arm and a right hand are denoted by 112R and 113R, and a robot arm 112 and a robot hand 113 which correspond to a left arm and a left hand are denoted by 112L and 113L.

In this embodiment, the first shoulder joint 121 of the right robot arm 112R and the first shoulder joint 121 of the left robot arm 112L are configured to be able to rotate separately. This configuration can be realized, for example, by using separate drive motors for the former shoulder joint 121 and the latter shoulder joint 121. This enables the arm robot 101 to perform various dual-arm operations.

FIG. 10 shows the robot 101 which is handling a work object (frying pan) 201. In FIG. 10, the robot 101 is putting ingredients in the frying pan 201 with the right hand, while holding the frying pan 201 with the left hand.

When carrying out such operations, the robot 101 rotates the first shoulder joint 121 of the right robot arm 112R so as to place the second shoulder joint 123 of the right robot arm 112R relatively forward, and rotates the first shoulder joint 121 of the left robot arm 112L so as to place the second shoulder joint 123 of the left robot arm 112L relatively backward. This allows the robot 101 to make the right robot arm 112R relatively longer, and the left robot arm 112L relatively shorter. Consequently, it becomes easier for the robot 101 to carry out operations such as shown in FIG. 10.

In this way, in this embodiment, the robot 101 can make one of the robot arms 112 relatively longer, and the other of the robot arms 112 relatively shorter. This makes it possible, for example, to carry out an operation on the work object 201 with one of the robot arms 112, while holding the work object 201 with the other of the robot arms 112.

On the other hand, in cases such as shown in FIG. 3A, the robot 101 may rotate the first shoulder joint 121 of the robot arm 112R so as to place the second shoulder joint 123 of the robot arm 112R relatively upward, and may rotate the first shoulder joint 121 of the robot arm 112L so as to place the second shoulder joint 123 of the robot arm 112L relatively downward. This allows the robot 101 to cross the robot arm 112R and the robot arm 112L in front of the robot body 111 as shown in FIG. 3A.

In this embodiment, the first shoulder joint 121 of the robot arm 112R and the first shoulder joint 121 of the robot arm 112L may be configured to rotate in conjunction with each other. This configuration can be realized, for example, by using the same drive motor for the former shoulder joint 121 and the latter shoulder joint 121. This configuration provides a limited variety of dual-arm operations compared to the configuration in FIG. 10. However, this configuration is simpler than the configuration in FIG. 10. Therefore, it is desirable to use such a configuration when there is no need to separately drive the first shoulder joint 121 of the robot arm 112R and the first shoulder joint 121 of the robot arm 112L.

As described above, the embodiment of the present invention can provide a robot which includes an excellent, lightweight robot arm of a simplified structure.

1. A robot comprising:
a robot body;
a first shoulder joint attached to the robot body, and rotatable with respect to the robot body;
a support unit whose proximal end is attached to the first shoulder joint, and which is rotatable with respect to the robot body together with the first shoulder joint;
a second shoulder joint attached to a distal end of the support unit, and rotatable with respect to the support unit; and
an arm unit whose proximal end is attached to the second shoulder joint, and which is rotatable with respect to the support unit together with the second shoulder joint.

2. The robot according to claim 1, further comprising:
a wrist joint attached to a distal end of the arm unit, and rotatable with respect to the arm unit; and
a hand unit attached to the wrist joint, and rotatable with respect to the arm unit together with the wrist joint.

3. The robot according to claim 1, wherein the arm unit comprises:
an upper arm unit whose proximal end is attached to the second shoulder joint;
an elbow joint attached to a distal end of the upper arm unit, and rotatable with respect to the upper arm unit; and
a forearm unit attached to the elbow joint, and rotatable with respect to the upper arm unit together with the elbow joint.

4. The robot according to claim 1, wherein:
when the first shoulder joint rotates with respect to the robot body, the first shoulder joint rotates on a certain rotation axis;
when the second shoulder joint rotates with respect to the support unit, the second shoulder joint rotates around a certain rotation center; and
when the first shoulder joint rotates on the rotation axis, the support unit and the second shoulder joint rotate around the rotation axis together with the first shoulder joint, and the rotation center rotates along a circular path whose center is on the rotation axis.

5. The robot according to claim 1, wherein the first shoulder joint has one degree of freedom, and the second shoulder joint has two degrees of freedom.

6. The robot according to claim 1, wherein the support unit is fixed to the first shoulder joint.

7. The robot according to claim 1, wherein the second shoulder joint is supported by the support unit.

8. The robot according to claim 1, wherein the first shoulder joint can be rotated so as to bring the second shoulder joint toward a distal end of the arm unit.

9. The robot according to claim 1, wherein the maximum movement angle of the second shoulder joint in a horizontal plane can be larger than 180 degrees.

10. The robot according to claim 1, wherein the shape of the robot body at least partly conforms to a rotational path along which the second shoulder joint rotates when rotating with respect to the robot body.

11. The robot according to claim 3, wherein the length of the upper arm unit is twice or more larger than the distance between the rotation axis of the first shoulder joint and the rotation center of the second shoulder joint.

12. The robot according to claim 1, wherein the first shoulder joint can be rotated so as to bring the second shoulder joint in the opposite direction from a distal end of the arm unit.

13. The robot according to claim 1, wherein:
the first shoulder joint is rotated so as to bring the second shoulder joint toward a work object, when the arm unit is used for work.

14. The robot according to claim 1, wherein:
the first shoulder joint is rotated so as to bring a distal end of the arm unit close to the robot body, when the arm unit is not used for work or when the arm unit is used to carry a thing.

15. A robot comprising:
a robot body; and
first and second robot arms attached to the robot body, each of the first and second robot arms comprising:
a first shoulder joint attached to the robot body, and rotatable with respect to the robot body,
a support unit whose proximal end is attached to the first shoulder joint, and which is rotatable with respect to the robot body together with the first shoulder joint,
a second shoulder joint attached to a distal end of the support unit, and rotatable with respect to the support unit, and
an arm unit whose proximal end is attached to the second shoulder joint, and which is rotatable with respect to the support unit together with the second shoulder joint.

16. The robot according to claim 15, further comprising:
first and second robot hands attached to the first and second robot arms respectively, each of the first and second robot hands comprising:
a wrist joint attached to a distal end of the arm unit, and rotatable with respect to the arm unit, and
a hand unit attached to the wrist joint, and rotatable with respect to the arm unit together with the wrist joint.

17. The robot according to claim 15, wherein each of the first and second robot arms comprises:
an upper arm unit whose proximal end is attached to the second shoulder joint;
an elbow joint attached to a distal end of the upper arm unit, and rotatable with respect to the upper arm unit; and
a forearm unit attached to the elbow joint, and rotatable with respect to the upper arm unit together with the elbow joint.

18. The robot according to claim 15, wherein one of the first and second robot arms is a right arm of the robot, and the other of the first and second robot arms is a left arm of the robot.

19. The robot according to claim 15, wherein:
the first shoulder joint of the first robot arm is rotated so as to place the second shoulder joint of the first robot arm relatively forward, and
the first shoulder joint of the second robot arm is rotated so as to place the second shoulder joint of the second robot arm relatively backward,
during a dual-arm operation.

20. The robot according to claim 15, wherein:
the first shoulder joint of the first robot arm is rotated so as to place the second shoulder joint of the first robot arm relatively upward, and
the first shoulder joint of the second robot arm is rotated so as to place the second shoulder joint of the second robot arm relatively downward,
for crossing the first and second robot arms in front of the robot body.
